(19) United States
(12) Patent Application Publication
(10) Pub. No.: US 2002/0165976 A1
(43) Pub. Date: Nov. 7, 2002

(54) Software deployment in a data communications network

(76) Inventors: Jean-Charles Gonthier, Outremont (CA); Eric Richer, Repentigny (CA); Gerald Host, Montreal (CA); Pierre-Luc Jodoin, Laval (CA); Robert-Claude Maltais, Repentigny (CA); Thomas Van Bunningen, Bromma (SE)

Correspondence Address: ERICSSON RESEARCH CANADA, 8400 DECARIE BLVD., MONTREAL, QC, H4P 2N2, CA

(21) Appl. No.: 09/682,678

(22) Filed: Oct. 4, 2001

Related U.S. Application Data
(60) Provisional application No. 60/287,734, filed on May 2, 2001.

(51) Int. Cl. G06F 15/177

(52) U.S. Cl. 709/237; 709/220

(57) ABSTRACT

The invention is a method for software deployment in a data communications network comprising an Initiator, a Service Provider, and a Peer. The Initiator selects a service and sends an interface request related to the service to the Service Provider. The Service Provider authenticates the request and responds with the interface that the Initiator uses to prepare a service request that is sent to the Service Provider. The Service Provider sends an invitation to the Peer that, if it accepts the service, sends an accept service message to the Service Provider that builds the software for the service and distributes it to the Initiator and the Peer that both install the software, and the service is initiated.

### CROSS REFERENCE TO RELATED APPLICATIONS

PRIORITY STATEMENT UNDER 35 U.S.C.119(e) & 37 C.F.R.S1.78. This non-provisional patent applications claims priority based upon the prior U.S. provisional patent application entitled “Software Deployment, Accounting and Personal Portal”, application No. 60/287,734 filed May 2, 2001, in the name of GONTHIER Jean-Charles, RICHER Eric, HOST Gerald, JODOIN Pierre-Luc, FOURNIER Nicolas, MALTAIS Robert Claude, VAN BUNNINGEN Thomas, HARNOIS Serge, WALLNER Sabine, BRASK Patrik.

### BACKGROUND OF INVENTION

1. Technical Field of the Invention

The present invention relates to data communication networks, and particularly to deployment of software in such networks.

2. Description of Related Art

Not that long ago, to install software on a terminal the software and the terminal had to meet physically, either by bringing the software to the terminal or the terminal to the software. As this obviously is difficult and time consuming in most cases, the growth of computer networks brought ways of distributing software over the network, something that today comes in different guises.

One method for distributing and downloading software to a computer (or other kind of terminal) is in a trusted network, where the user simply downloads the software from a file server and installs it himself, usually by activating a self installing program.

In many cases, however, a company needs to keep track of the number of versions of a certain program that are installed on its computers. This is needed in order to pay license fees to the software providers. In these cases, it is common for the company's network administrators to handle the distribution of data, usually by some kind of remote installation procedure.

In other cases, a user may download software from a software provider on the Internet and install it on his terminal. This is a variation on the above-mentioned theme in that there is no trusted network. Hence the software will, unless it is free, have to be paid for somehow, usually using credit cards.

Once downloaded, the software may be self-installing so that the user can relax until the installation is finished, or possibly answer some questions as to preferences and so on. These questions may be answered beforehand, for instance when ordering the download of the software, in which case the software may come pre-configured.

All these instances, however, describe situations in which software is downloaded and installed on a single terminal, although it is of course possible to repeat the procedure from other terminals.

There is as of today no known procedure that in an easy manner lets a user order the download of software to his own terminal as well as one or more other terminals, have this software automatically configured and installed and then billed for.

It can therefore be appreciated that there is a need for a solution that overcomes the problems and limitations of the prior art. This invention provides such a solution.

### SUMMARY OF INVENTION

The present invention is directed to a method for software deployment in a data communications network that comprises an Initiator, a Service Provider, and a Peer. The Initiator sends a service request comprising the address of the Peer to the Service Provider that sends an invitation to the Peer. If the Peer accepts the service, it sends an accept service message to the Service Provider that builds the software for the service and distributes it to the Initiator and the Peer. The Initiator and the Peer install the software, and the service is initiated.

The present invention is further directed to a system for software deployment in a data communications network. The system comprises an Initiator, a Service Provider, and a Peer. The Initiator sends a service request comprising the address of the Peer to the Service Provider, and installs software received from the Service Provider. The Service Provider sends an invitation to the Peer, builds the software for the service, and distributes the software to the Initiator and the Peer. The Peer sends an accept service message from the Peer to the Service Provider, and installs software received from the Service Provider.

The present invention is further directed to an Initiator of software deployment in a data communications network that further comprises a Service Provider and a Peer. The Initiator comprises a communication unit that sends a service request comprising the address of the Peer to the Service Provider, and receives the software for the service from the Service Provider. The Initiator also comprises a processing unit that installs the software.

The present invention is further directed to a Peer in software deployment in a data communications network that further comprises an Initiator and a Service Provider. The Peer comprises a communication unit that receives an invitation from the Service Provider, sends an accept service message to the Service Provider, and receives software from the Service Provider. The Peer further comprises a processing unit that installs the software

The present invention is further directed to a Service Provider for software deployment in a data communications network. The network further comprises an Initiator and a Peer. The Service Provider comprises a communication unit that receives a service request comprising the address of the Peer from the Initiator, sends an invitation to the Peer, receives an accept service message from the Peer, and distributes the software to the Initiator and the Peer. The Service Provider further comprises a processing unit that builds the software for the service.

### BRIEF DESCRIPTION OF DRAWINGS

A more complete understanding of the present invention may be had by reference to the following Detailed Description when taken in conjunction with the accompanying drawings wherein:

FIG. 1 depicts a block chart of an exemplary network environment in which the invention may be used;

FIG. 2 depicts a signal flow chart of a preferred embodiment of the method according to the invention; and

FIG. 3 depicts a simplified block chart of an exemplary network node.

### DETAILED DESCRIPTION

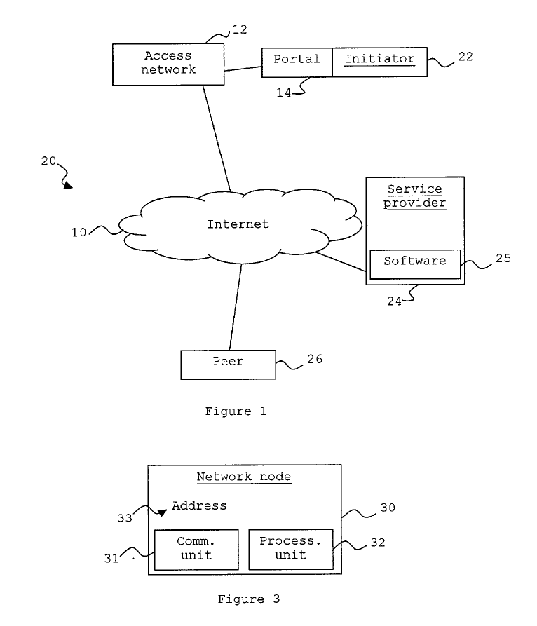

Reference is now made to the Drawings, where FIG. 1 depicts a block chart of an exemplary network environment in which the invention may be used. In the network 20, are shown two users, an Initiator 22 and a Peer 26. The Initiator 22 has access to the Internet 10 through an access network 12, while the Peer 26 has a direct connection to the Internet 10. The network 20 further comprises a Service Provider 24, also directly connected to the Internet 10. The Service Provider 24 among other things stores software 25 for the services it provides.

In an exemplary scenario, the Initiator 22 wishes to share with the Peer 26 the use of a service provided by the Service Provider 24. The service may for example be a game that the Initiator 22 wants to play with the Peer 26, or some kind of communication service such as a telecommunication connection. Neither the Initiator 22 nor the Peer 26 has the proper software to use the service. On the other hand, the Service Provider 24 has the necessary software and is willing to let users partake of this software for a fee that for example may depend on the length of the utilisation.

Hereinafter it will be assumed that the Initiator 22 has access to a Portal 14 residing on his own device (not shown). The Portal 14 could however also reside elsewhere in the network 20, as long as the Initiator 22 has access to it. It will also be assumed that the Initiator 22 trusts the Portal 14, that the Initiator 22 is logged on to the Portal 14, and that the Portal 14 has access to or stores information such as for example the identity of the Initiator 22 and security association data (see description of security associations hereinafter). It should be noted that it is not necessary for these assumptions to be true in order for the method according to the invention to work. Using the Portal 14 does however greatly facilitate the working of the method as it automates steps that otherwise would be initiated or performed manually by the Initiator 22.

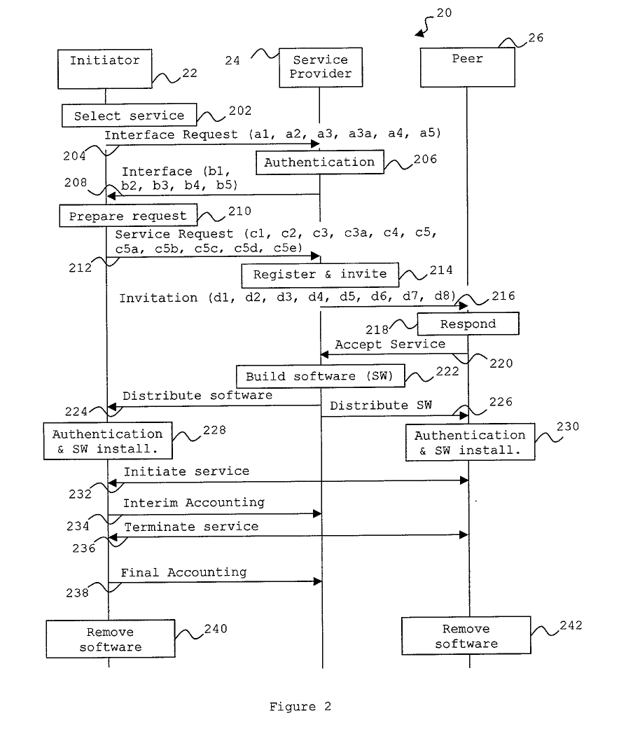

FIG. 2 depicts a signal flow chart of a preferred embodiment of the method according to the invention. The figure shows, in a network 20, a Service Provider 24 and two users: an Initiator 22 and a Peer 26. It is to be understood however that there may be more than one peer.

One way of authentication in a network is for two or more entities to have valid security association. This may for instance be a shared secret that no one else knows about. When one entity wants to authenticate another entity it asks for their shared secret and if the response comprises the correct secret, then the other entity is authenticated. An example of such a secret is an encryption key. The first entity draws a random number and sends it to the second entity. Both entities encrypt the number using their shared encryption key. The second entity sends the encrypted number to the first entity that then is able to compare the two encrypted numbers. Encrypting random numbers one way of making sure that a third entity may not learn the shared secret, as the secret is not the number itself nor its encrypted version, but rather the encryption key per se.

Another example is public key encryption (PKE) where an entity has a private key that only the entity itself knows and a public key that may be known to the entire world. A message encrypted with the public key may only be decrypted with the corresponding private key, and vice versa. Hence, a message encrypted with the private key may be said to have been signed by the corresponding entity; an electronic signature so to speak. This way an entity that only knows the public key of another entity, may ask that entity for the public keys of other entities. Thus, two entities that previously did not know each other's public keys may gain knowledge of this, often through an entity they both trust. It will be understood that the invention is not the security associations in themselves; rather it makes use of security associations.

A person skilled in the art will appreciate that these were merely two examples of security associations and that many other variants exist.

It is assumed that the Initiator 22 shares a valid security association with the Peer 26 and another valid security association with the Service Provider 24. It is however also possible for the Initiator 22 to negotiate valid security associations using prior art techniques, for example through a so-called broker. The Initiator 22, the Service Provider 24, and the Peer 26 are connected to the network 20, and these three entities may contact one another through the network 20. In case the Initiator 22, the peer 24, or both the Initiator 22 and the Peer 26 are for example human beings, then the network connection is achieved via some sort of device that provides the connection, although in the description hereinafter there may be references to just the entities, which may comprise the user and the device or just the device, as the case may be.

The Initiator 22 further has his Portal 14 (see FIG. 1) activated. This may for example be an Internet portal through which he can use services and browse for information. It is through this Portal 14 that the Initiator 22 may access the Service Provider 24; the Portal 14 may for example provide a link to the Service Provider 24. The Portal 14 itself is however beyond the scope of this invention.

Turning now to the description of the method according to the invention. In step 202, the Initiator 22 selects a service provided by the Service Provider 24 through the Portal 14, upon which an Interface Request message 204 is sent to the Service Provider 24. This message comprises:

The address of the Initiator 22 (a1). This address may for instance be the IP address or a user address, such as for example “John.Doe@JohnDoe.com”.

A unique identifier for the Interface Request 204 (a2).

An indication of the requested service (a3). The indication may also comprise options (a3a) relevant for the presentation of the requested service, such as for example language and display capability.

A random number to be used for authentication using the security association (a4).

An electronic signature that authenticates the Initiator 22 to the Service Provider 24 (a5).

The Service Provider 24 then authenticates the Interface Request 204, step 206, and responds with an Interface 208 configured with the options from the Interface Request 204, i.e. having the requested language, display characteristics or whatever was requested in the Interface Request 204. The Interface 208 comprises:

The unique identifier from the Interface Request 204 (b1).

The requested service interface (b2) with any relevant options (e.g. language).

A random value to be used in the subsequent service request 212 (b3).

A key to be sent to any peers that the Initiator 22 may wish to contact (b4).

An electronic signature that authenticates the Service Provider 24 to the Initiator 22 (b5).

In step 210, the Initiator 22 prepares and sends, using the Interface 208 to the Service Provider 24 a Service Request 212 comprising:

The unique identifier sent in the Interface Request 204 (c1).

A unique identifier for the Service Request 212 (c2).

An identification of the requested service (c3), normally with any configuration options (c3a), such as for example the kind of connection that is desired with the peers, and particulars of the game that is wanted.

An electronic signature that authenticates the Initiator 22 to the Service Provider 24 (c4).

A list of peers (in this example only the Peer 26) that the Initiator 22 wishes to share the service with (c5). The message comprises the following information for each peer:

The address of the peer (e.g. URL or IP address) (c5a).

A notification describing the service that is offered (c5b).

An identifier of the Initiator 22 (c53). The identifier is preferably one that the peer can identify without having to consult any other entity.

The key from the Interface 208 (c54).

An electronic signature that authenticates the Initiator 22 (c55). Once again, it is preferable if the peer can authenticate the Initiator 22 without having to consult any other entity.

Upon reception of the Service Request 212, the Service Provider 24 registers the options and sends an Invitation 216 to invited peers, i.e. the Peer 26; step 214.

The Invitation 216 comprises:

A unique identifier for the Invitation 216 (d1).

Identification of the offered service with the configuration options selected by the Initiator 22 (d2).

An interface to use for the response (d3).

The address of the Initiator 22 (d4). If this is not already known, then the Service Provider 24 may use for example a Domain Name Server (DNS) to determine the IP address of the Initiator 22.

The identifier of the Initiator 22 (d5).

A notification with information about who the Initiator 22 is and what the offered service is (d6).

The key provided by the Service Provider 24 in the Interface 208 (d7).

An electronic signature authenticating the Initiator 22 to the Peer 26 (d8).

The Peer 26 may then respond to the Invitation 21 6. In this example, it is assumed that the Peer 26 accepts the Invitation 216 and therefore responds with an Accept Service message 220 signed using the received key. The message 220 comprises:

Options selected by the Peer 26, if any such options were available. These options are left to the Peer's 26 discretion and may for example be display information or language. The Initiator 22, the Service Provider 24, or both the Initiator 22 and the Service Provider 24 may provide these options.

The Service Provider 24 awaits a sufficient number of responses from the peers before continuing with the next step. What a sufficient number is may depend on several things according on some predefined rule. First, it is sufficient when all the peers have responded. Second, it may be sufficient if at least one peer has responded and a previously set time limit for waiting has expired. Third, it may be sufficient if at least the minimum number of peers needed for the service have accepted. In any case, a predefined minimum number of peers must have accepted the service for the method to go on with the next step. Otherwise, the method may end, perhaps after a predefined time limit, or the Initiator 22 may be informed and possibly offered another service solution.

The Service Provider 24 now builds the software according to the options, step 222. The Service Provider 24 signs the software so that the users can trust it. The software is also distributed to the Initiator 22 and the Peer 26 in 224 and 226 respectively.

The Initiator 22 and the Peer 26 then authenticates the software and, if this is successfully done, the software is installed and automatically started, steps 228 and 230 respectively, and thus the service is initiated, 232. Any signalling needed for the software to communicate with for example other users is specific to the software itself and falls outside the scope of this invention. The software can also be configured to send, possibly periodic, Interim Accounting messages 234 during the service session and a Final Accounting message 238 after the service session. It should be understood that the Interim Accounting messages 234 and the Final Accounting message 238 also may be sent to another accounting entity in the network than the Service Provider 24.

At 236, one or more users terminate the service session. In this example with only two users, it may well be decided beforehand that the service is terminated for both users as soon as one of them terminates the service. If more users are involved, it may be possible for the remaining users to continue using the service.

If the Initiator 22 terminates the service it may be necessary to select a peer who will pay for the continued use of the service.

The software may be configured to remove itself from the devices once the service has been terminated, step 240 for the Initiator 22 and step 242 for the Peer 26, but it is also possible for the software to remain longer, such as for example a certain number of uses or a certain time period.

FIG. 3 depicts an exemplary network node such as for example a Service Provider 24. The network node 30 comprises a communication unit 31 for communication with other nodes in the network and a processing unit 32 for processing data. The network node 30 also has a network address 33.

Although several preferred embodiments of the methods, systems and nodes of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for software deployment in a data communications network that comprises an Initiator having an address, a Service Provider, and at least one Peer having an address, the method comprising the steps of:
sending a service request comprising the address of the at least one Peer from the Initiator to the Service Provider;
sending an invitation for the service from the Service Provider to the at least one Peer;
if the at least one Peer accepts the service, sending an accept service message from the at least one Peer to the Service Provider;
building by the Service Provider the software for the service;
distributing by the Service Provider the software to the Initiator and the Peer;
installing the software by the Initiator;
installing the software by the at least one Peer; and
initiating the service.

2. The method for software deployment according to claim 1, further comprising, prior to the step of sending an invitation from the Service Provider to the at least one Peer, the step of registering by the Service Provider the service request.

3. The method for software deployment according to claim 1, further comprising, prior to the step of installing the software by the Initiator, the step of authenticating the software by the Initiator.

4. The method for software deployment according to claim 1, further comprising, prior to the step of installing the software by the at least one Peer, the step of authenticating the software by the at least one Peer.

5. The method for software deployment according to claim 1, further comprising, prior to the step of sending a service request comprising the address of the at least one Peer from the Initiator to the Service Provider, the steps of:
selecting by the Initiator a service;
sending an interface request relating to the selected service from the Initiator to the Service Provider;
sending the requested interface from the Service Provider to the Initiator; and
preparing by the Initiator a service request using the interface.

6. The method for software deployment according to claim 5, further comprising, prior to the step of sending the requested interface from the Service Provider to the Initiator, the step of authenticating by the Service Provider the interface request.

7. The method for software deployment according to claim 1, further comprising, after the step of initiating the service, the steps of:
terminating the service; and
sending a final accounting message from the Initiator to the Service Provider.

8. The method for software deployment according to claim 7, further comprising, prior to the step of terminating the service, the step of sending at least one interim accounting message from the Initiator to the Service Provider.

9. The method for software deployment according to claim 1, further comprising, after the step of terminating the service, the step of removing by the Initiator the software.

10. The method for software deployment according to claim 1, further comprising, after the step of terminating the service, the step of removing by the at least one Peer the software.

11. The method for software deployment according to claim 5, wherein the interface request comprises:
the address of the Initiator;
a unique identifier for the interface request;
an indication of the requested service;
a random number to be used for authentication; and
an electronic signature that authenticates the Initiator to the Service Provider.

12. The method for software deployment according to claim 11, wherein the indication of the requested service comprises options relevant for the presentation of the requested service.

13. The method for software deployment according to claim 11, wherein the interface comprises:
the unique identifier from the Interface Request;
the requested service interface;
a random value;
a key;
an electronic signature that authenticates the Service Provider to the Initiator.

14. The method for software deployment according to claim 13 wherein the service request comprises:
the unique identifier in the interface request;
a unique identifier for the service request;
an identification of the requested service;
an electronic signature that authenticates the Initiator to the Service Provider; and
a list of at least one Peer, for each Peer comprising:
the address of the Peer;
a notification describing the service;
an identifier of the Initiator;
the key from the interface; and
an electronic signature that authenticates the Initiator.

15. The method for software deployment according to claim 14, wherein the identification of the requested service comprises configuration options.

16. The method for software deployment according to claim 15, wherein the invitation comprises:
a unique identifier for the invitation;
the identification of the offered service with the configuration options;
an interface;
the address of the Initiator;
the identifier of the Initiator;
information about who the Initiator is and what the service is;
the key from the interface; and
an electronic signature authenticating the Initiator to the at least one Peer.

17. A system for software deployment in a data communications network, the system comprising:
an Initiator, having an address, that:
sends a service request comprising the address of at least one Peer to a Service Provider; and
installs software received from the Service Provider;
a Service Provider that:
sends an invitation for the service to the at least one Peer;
builds the software for the service; and
distributes the software to the Initiator and the at least one Peer; and
at least one Peer, having an address, that:
sends an accept service message to the Service Provider; and
installs software received from the Service Provider.

18. The system for software deployment according to claim 17, wherein the Service Provider further registers the service request.

19. The system for software deployment according to claim 17, wherein the Initiator further authenticates the software.

20. The system for software deployment according to claim 17, wherein the at least one Peer further authenticates the software.

21. The system for software deployment according to claim 17, wherein:
the Initiator further:
selects a service;
sends an interface request relating to the selected service to the Service Provider; and
prepares a service request using the interface; and
the Service Provider further sends the requested interface to the Initiator.

22. The system for software deployment according to claim 21, wherein the Service Provider further authenticates the interface request.

23. The system for software deployment according to claim 17, wherein the Initiator further sends a final accounting message to the Service Provider.

24. The system for software deployment according to claim 23, wherein the Initiator further sends at least one interim accounting message to the Service Provider.

25. The system for software deployment according to claim 17, wherein the Initiator further removes the software.

26. The system for software deployment according to claim 17, wherein the at least one Peer further removes the software.

27. The system for software deployment according to claim 21, wherein the interface request comprises:
the address of the Initiator;
a unique identifier for the interface request;
an indication of the requested service;
a random number to be used for authentication; and
an electronic signature that authenticates the Initiator to the Service Provider.

28. The system for software deployment according to claim 27, wherein the indication of the requested service comprises options relevant for the presentation of the requested service.

29. The system for software deployment according to claim 27, wherein the interface comprises:
the unique identifier from the Interface Request;
the requested service interface;
a random value;
a key;
an electronic signature that authenticates the Service Provider to the Initiator.

30. The system for software deployment according to claim 29 wherein the service request comprises:
the unique identifier in the interface request;
a unique identifier for the service request;
an identification of the requested service;
an electronic signature that authenticates the Initiator to the Service Provider; and
a list of at least one Peer, for each peer comprising:
the address of the Peer;
a notification describing the service;
an identifier of the Initiator;
the key from the interface; and
an electronic signature that authenticates the Initiator.

31. The system for software deployment according to claim 30, wherein the identification of the requested service comprises configuration options.

32. The system for software deployment according to claim 31, wherein the invitation comprises:
a unique identifier for the invitation;
the identification of the offered service with the configuration options;
an interface;
the address of the Initiator;
the identifier of the Initiator;
information about who the Initiator is and what the service is;
the key from the interface; and
an electronic signature authenticating the Initiator to the at least one Peer.

33. An Initiator of software deployment in a data communications network that further comprises a Service Provider, and at least one Peer having an address, the Initiator comprising:
a communication unit that:
sends a service request comprising the address of the at least one Peer to the Service Provider; and
receives the software for the service from the Service Provider; and
a processing unit that:
installs the software.

34. The Initiator of software deployment according to claim 33, wherein the processing unit further authenticates the software.

35. The Initiator of software deployment according to claim 33, wherein:
the processing unit further:
selects a service; and
prepares a service request using the interface; and
the communication unit further:
sends an interface request relating to the selected service from the Initiator to the Service Provider; and
sends the requested interface from the Service Provider to the Initiator.

36. The Initiator of software deployment according to claim 33, wherein the communication unit further sends a final accounting message to the Service Provider.

37. The Initiator of software deployment according to claim 33, wherein the communication unit further sends at least one interim accounting message to the Service Provider.

38. The Initiator of software deployment according to claim 33, wherein the processing unit further removes the software.

39. A Peer in software deployment in a data communications network that further comprises an Initiator and a Service Provider, wherein the Peer comprises:
a communication unit that:
receives an invitation from the Service Provider;
sends an accept service message to the Service Provider; and
receives software from the Service Provider; and
a processing unit that:
installs the software.

40. The Peer in software deployment according to claim 39, wherein the processing unit further authenticates the software.

41. The Peer in software deployment according to claim 39, wherein the processing unit further removes the software.

42. A Service Provider for software deployment in a data communications network, the network further comprising an Initiator and at least one Peer having an address, the Service Provider comprising:
a communication unit that:
receives a service request comprising the address of the at least one Peer from the Initiator;
sends an invitation to the at least one Peer;
receives an accept service message from the at least one Peer; and
distributes the software to the Initiator and the at least one Peer; and
a processing unit that:
builds the software for the service.

43. The Service Provider for software deployment according to claim 42, wherein the processing unit further registers the service request.

44. The Service Provider for software deployment according to claim 42,
wherein the communication unit further:
receives an interface request relating to the selected service from the Initiator; and
sends the requested interface to the Initiator.

45. The Service Provider for software deployment according to claim 44, wherein the processing unit further authenticates the interface request.

46. The Service Provider for software deployment according to claim 42, wherein the communication unit further receives a final accounting message from the Initiator.

47. The Service Provider for software deployment according to claim 46, wherein the communication unit further receives at least one interim accounting message from the Initiator.
